(19) United States
(12) Patent Application Publication
(10) Pub. No.: US 2012/0331181 A1
(43) Pub. Date: Dec. 27, 2012

(54) METHODS AND STRUCTURE FOR FIRMWARE UPGRADE OF DEVICES IN A STORAGE NETWORK

(75) Inventors: Nilesh S. Govande, Pune (IN); Rakesh Verma, Mumbai (IN); Vishal R. Thakkar, Pune (IN)

(73) Assignee: LSI CORPORATION, Milpitas, CA (US)

(21) Appl. No.: 13/164,965

(22) Filed: Jun. 21, 2011

(51) Int. Cl. G06F 9/445; G06F 3/00

(52) U.S. Cl. 710/8

(57) ABSTRACT

Methods and systems for improved update of firmware for components in a storage system/network. A storage network comprising one or more initiator components coupled through one or more switching components to one or more target components may be updated by generating and distributing a package buffer comprising portions where each portion comprises firmware for a corresponding type of component. Switching and/or initiator components in the system locate a portion of the package buffer for each target component directly coupled to it and transmits the located, corresponding portion (comprising firmware) to each target component. Each initiator/switching component then also forwards the entire package buffer to each other switching component coupled with it and the process repeats until all components have received updated firmware.

### BACKGROUND

1. Field of the Invention

The invention relates generally to storage systems and more specifically relates to methods and structure for improved processing to distribute firmware upgrades to all devices in a storage network.

2. Discussion of Related Art

A storage network comprises one or more host systems coupled through a switched fabric communication medium to a plurality of storage devices. The storage devices may comprise, for example, individual disk drives (e.g., Solid-State Drives, magnetic disk drives, or optical disk drives). The switched fabric communication medium may comprise, for example, Serial Attached SCSI (SAS), Fibre Channel (FC), Ethernet (e.g., iSCSI, FC over Ethernet, etc.) and other well known, commercially available communication media and corresponding protocols.

In a storage network (often referred to as a “domain” or a “storage domain”), many (if not all) devices in the domain have embedded software (e.g., “firmware”) to control their operation and to provide connectivity for the switched fabric communication medium and associated protocol layers. It is common in such environments that the firmware in some or all of the devices needs to be upgraded from time to time. Upgrades may provide performance enhancements, feature enhancements, and/or bug fixes to improve performance and/or reliability of the various devices in the domain.

For example, in a SAS domain, one or more SAS initiators (e.g., host systems/servers and/or storage controllers) may be coupled through a SAS fabric to a plurality of SAS target devices (e.g., disk drives or other storage devices). The SAS fabric may comprise one or more SAS expanders and associated interconnecting cabling. Some or all of the SAS devices (initiators, expanders, and targets) may require firmware upgrades from time to time.

As presently practiced, an administrator may manually update each device. The administrator determines the vendor and/or model of each device, locates the updated firmware file/files for the device, and transmits the updated firmware to the device for installation therein. The administrator repeats the process for each device. Some administrative tools may be provided by vendors to aid in the process but essentially the tools merely simplify the process for the administrator in identifying the vendor/model of a device and transmitting the updated firmware file/files to each device. The administrator still processes each device essentially individually.

Other present practices may somewhat automate the process in that an administrative tool could automatically determine the vendor/model for each device, automatically locate an updated firmware file, and transmit the firmware to the device. Even such an automated tool still processes one device at a time.

The present practice of processing the upgrade of devices in a storage network one device at a time is cumbersome and time consuming with respect to the host (e.g., SAS initiator) from which the upgrades are disseminated. Further, to whatever extent manual intervention is required of the updating process, the procedure may be prone to errors.

Thus it is an ongoing challenge to improve the process of updating firmware in a plurality of devices in a storage network.

### SUMMARY

The present invention solves the above and other problems, thereby advancing the state of the useful arts, by providing methods and systems for updating firmware in a storage network of components. A storage network comprising one or more initiator components coupled through one or more switching components to one or more target components may be updated by generating and distributing a package buffer comprising portions where each portion comprises firmware for a corresponding type of component. Switching and/or initiator components in the system locate a portion of the package buffer for each target component directly coupled to it and transmits the located, corresponding portion (comprising firmware) to each target component. Each initiator/switching component then also forwards the entire package buffer to each other switching component coupled with it and the process repeats until all components capable of being updated have received updated firmware. Those of ordinary skill in the art will recognize that a system may comprise a plurality of components capable of propagating updated firmware in accordance with features and aspects hereof as well as one or more components (e.g., legacy components) that do not participate in the improved update propagation features hereof Thus, “targeted components” or “all targeted components” as used herein means those components of a storage system that participate in the improved firmware update process. More generally, reference to “all components” of a system or “each component” of a system in reference to the improved update procedures hereof refers to all targeted components—i.e., those components capable of participating in the improved update features hereof The claimed methods and structures relate to a plurality of components (e.g., “targeted components”) participating in the claimed, improved, update processing—regardless of whether there are other components of the system that may not participate in the update processing. In a Serial Attached SCSI (SAS) environment, a SAS initiator may generate the package buffer and transmit it to each SAS expander coupled to it. Each SAS expander then updates its own firmware by locating a corresponding portion of the package buffer comprising its firmware. The expander then locates a corresponding portion for each SAS target coupled to it and transmits that portion to each target device to update its firmware. Each expander then forwards the entire package buffer to other SAS expanders coupled to it and the process repeats until all devices of the SAS domain have been updated.

In one aspect hereof, a method is provided for updating firmware for a plurality of components of a storage network. The plurality of components comprising one or more switching components and one or more target components. The method comprises receiving in a switching component a package buffer comprising firmware for each of the plurality of components and updating firmware in the switching component based on a portion of the package buffer comprising firmware for the switching component. The method further comprises, for each target component coupled directly to the switching component, performing the additional steps of: transmitting from the switching component to said each target component a corresponding portion of the package buffer comprising firmware for said each target component; and updating firmware in said each target component based on the corresponding portion of the package buffer received from the switching component. The method still further comprises, for each other switching component directly coupled with the switching component, performing the additional steps of: transmitting the package buffer from the switching component to said each other switching component; and repeating the method within said each other switching component.

Another aspect hereof provides a storage system comprising an initiator component, a switching component coupled with the initiator component, and one or more target components coupled with the switching component. The switching component is adapted to receive a package buffer comprising firmware for the switching component and for the one or more target components. The switching component is further adapted to update its firmware based on a portion of the package buffer comprising firmware for the switching component. The switching component is further adapted to locate a portion of the package buffer comprising firmware for each of the one or more target components. The switching component is further adapted to transmit the located portion for each of the one or more target components to the corresponding target component to permit update of the firmware in each of the one or more target components.

### BRIEF DESCRIPTION OF THE DRAWINGS

FIG. 1 is a block diagram of an exemplary storage system enhanced in accordance with features and aspects hereof to provide improved upgrade of firmware of components of the system.

FIG. 2 is a block diagram of an exemplary SAS storage network enhanced in accordance with features and aspects hereof to provide improved upgrade of firmware of devices of the system.

FIGS. 3 and 4 are flowcharts describing exemplary methods in accordance with features and aspects hereof to provide improved upgrade of firmware of devices of the system.

FIGS. 5 through 7 are diagrams of exemplary data structures useful in the context of the systems and methods of FIGS. 1 through 4.

### DETAILED DESCRIPTION OF THE DRAWINGS

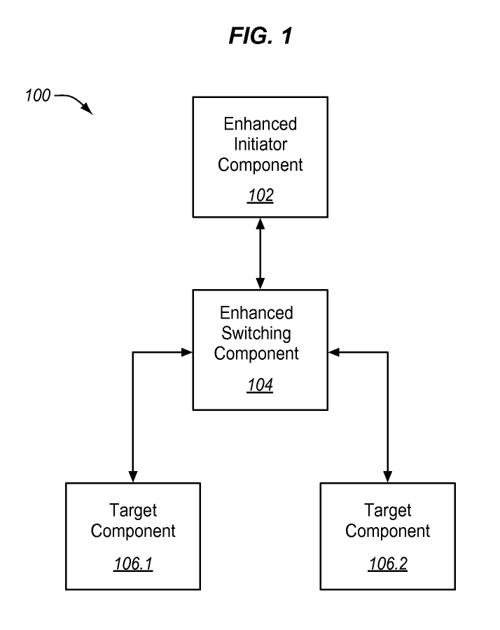

FIG. 1 is a block diagram of an exemplary storage system 100 enhanced in accordance with features and aspects hereof to improve updating of firmware of components of storage system 100. System 100 comprises an enhanced initiator component 102 coupled with one or more enhanced switching components 104. Each enhanced switching component 104 is, in turn, coupled with one or more target components 106.1 and 106.2. In a typical storage system, initiator component 102 may comprise any storage controller including, for example, a host bus adapter (HBA), a storage controller embedded within a storage system, a storage network appliance coupled to other components of the storage system, etc. In such an exemplary storage system 100, target components 106.1 and 106.2 may each comprise, for example, an independent storage device such as an optical, magnetic, or solid-state disk drives, an enclosure of such storage devices (e.g., just a box of disks—JBOD), or an entire storage subsystem including, for example, RAID storage management or other storage management techniques. Initiator component 102 and target components 106.1 and 16.2 may be coupled by any number of switching components 104. Collectively, such a network of one or more switching components may be generally referred to as a “switched fabric”. In some exemplary embodiments, the switched fabric may provide Fibre Channel (FC) connectivity using FC switching devices as switching components. In other exemplary embodiments, the switched fabric may provide Serial Attached SCSI (SAS) connectivity (including Serial Advanced Technology Attachment—SATA) using SAS expanders as switching components.

Initiator component 102 is enhanced in accordance with features and aspects hereof to generate a package buffer. A package buffer comprises a plurality of portions, each portion comprising firmware for a corresponding type of component in storage system 100. Having so generated a package buffer, initiator component 102 transmits the package buffer to each enhanced switching component 104 coupled directly with initiator component 102. Enhanced switching component 104 is enhanced in accordance with features and aspects hereof to receive the package buffer and to update its firmware and the firmware of other components directly coupled to the switching component 104. In particular, enhanced switching component 104 locates a portion of the package buffer comprising its firmware and updates its firmware based on the located portion of the package buffer corresponding with enhanced switching component 104. Further, enhanced switching component 104 identifies portions of the package buffer corresponding to each target component 106.1 through 106.2 directly coupled with enhanced switching component 104. The identified portion of the package buffer corresponding to each target component is then transmitted to each target component to update firmware in those components.

More generally, as discussed further herein below, each switching component 104 updates its own firmware and that of any target components directly coupled thereto. Further, each switching component 104 also forwards the entire package buffer to any other switching component directly coupled to it. The method of operation may be then repeated in each enhanced switching component of storage system 100. Thus, the operation of system 100 in accordance with features and aspects hereof propagates firmware updates to all components of storage system 100 using a package buffer propagated from an initiator component of the system

Those of ordinary skill in the art will readily recognize that any number of enhanced switching components 104 and target devices 106 may be present in storage system 100 subject to the limitations of particular protocols and communication media utilized in system 100. Further, those of ordinary skill in the art also recognize that enhanced initiator component 102 may be any component or device capable of acting in the role of an initiator in the protocols and communication media of storage system 100. In some exemplary embodiments, enhanced initiator component 102 may simply be another switching component of system 100.

Still further, those of ordinary skill in the art will readily recognize that “directly coupled” as used herein refers to components coupled to one another without intervening switching components. It will be further recognized that “directly coupled” components may be joined by appropriate cabling to provide the desired communication medium as well as amplifiers, filters, antennae, etc. and are still considered “directly coupled” in the context of this patent.

By contrast with prior techniques, enhanced storage system 100 of FIG. 1 permits simpler, more flexible propagation of firmware updates throughout components of a storage system. A package buffer is propagated through all components of the storage system such that any component in the system may be updated from information in the disseminated package buffer. Switching components of system 100 provide for the propagation of the package buffer among all switching components of the system and further provides for updating of each switching and target component in the system.

A package buffer may comprise portions for each of a plurality of components of the system and each such portion of the package buffer may be the entirety of the firmware update for a corresponding component. Such a package buffer may be large where a large number of components, each having a large update, are present in the system. Such a large package buffer may present problems where some components (e.g., switching components) have limited memory space for storing such a package buffer. Thus, those of ordinary skill in the art will recognize that multiple package buffers may be generated and propagated through system 100 where memory size limitations may restrict the maximum size of a package buffer (e.g., memory limitations within the various switching components and/or within the initiator that generates the package buffer). Where such size limitations so require generation of multiple package buffers, each package buffer comprises portions of firmware for one or more corresponding components of system 100. Each portion may be either the entirety of the firmware update for a corresponding component or may represent a subset of the entire firmware update for a corresponding component. A first package buffer generated would typically comprise a portion of firmware for each of the targeted components of the storage system (i.e., at least all components capable of propagating the package buffer and all components capable of being updated in accordance with features and aspects hereof). Since the size of firmware for each of various components of the system may vary, subsequent package buffers may comprise portions only for those components that require further portions to receive the entirety of their respective firmware update.

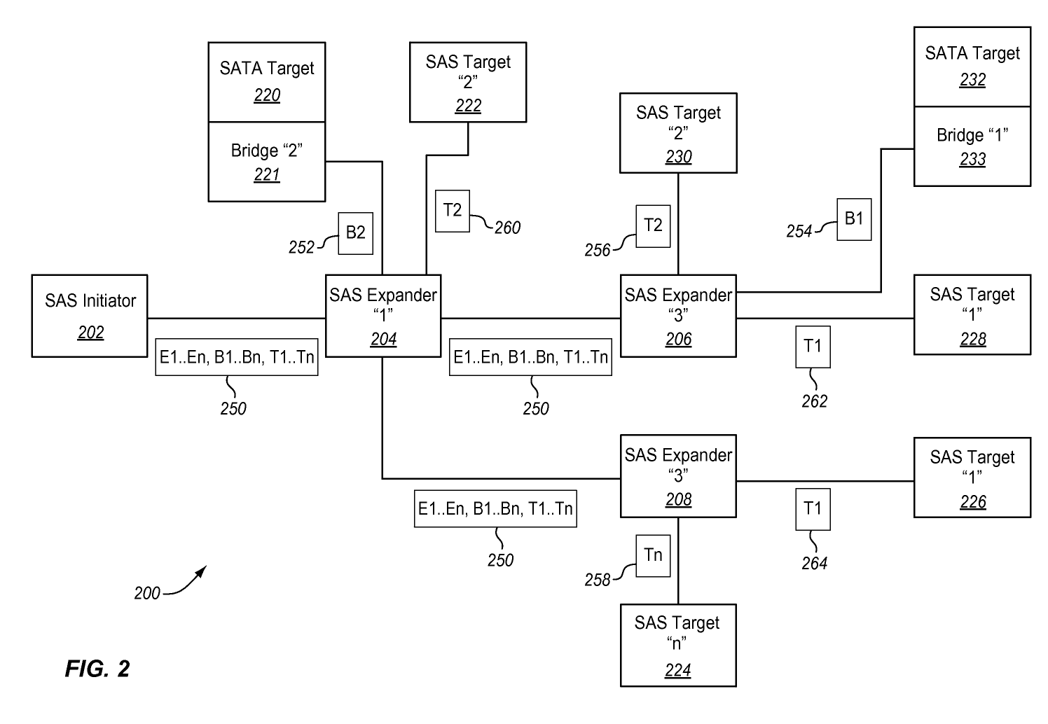

FIG. 2 is a block diagram of another exemplary embodiment of a storage system (e.g., “storage network”) 200 enhanced in accordance with features and aspects hereof to improve propagation of firmware updates throughout devices of storage system 200. Storage system 200 comprises a plurality of SAS devices including SAS initiator 202 directly coupled with SAS expander 204. SAS expander 204 is, in turn, directly coupled with SAS expanders 206 and 208. Various SAS target devices are directly coupled with the various SAS expanders 204, 206, and 208. In particular, SATA target device 220 is coupled through SAS to SATA bridge 221 with SAS expander 204. SAS target device 222 is directly coupled with SAS expander 204. SAS target devices 228 and 230 are directly coupled with SAS expander 206 while SATA target device 232 is coupled through SAS to SATA bridge device 233 with SAS expander 206. SAS target devices 224 and 226 are each directly coupled with SAS expander 208. Those of ordinary skill will readily recognize that any SAS domain topology may be employed in conjunction with features and aspects hereof. Thus, system 200 is merely intended as exemplary of one possible topology useful in explaining features and aspects hereof.

In operation, SAS initiator 202 generates package buffer 250 and transfers the package buffer to SAS expander 204 (and any other SAS expanders directly coupled with SAS initiator 202). SAS expander 204 updates its own firmware by locating an appropriate portion of package buffer 250 comprising its firmware. As depicted in FIG. 2, each SAS expander is indicated to be of a particular type (simply indicated as expander types “1” and “3”). More specifically, for example, a particular device is identified by a Product ID where the device is provided by a particular vendor identified by a Vendor ID. Thus, SAS expander 204 locates in the package buffer a portion denoted as type “E1” (e.g., expander type “1”) for updating of its own firmware.

In addition, SAS expander 204 transmits the received package buffer 250 to each additional SAS expander directly coupled with it. In particular, SAS expander 204 transmits the package buffer 250 to SAS expander 206 and to SAS expander 208.

As shown in FIG. 2, SAS expanders 206 and 208 both represent a type “3” expander (e.g., another particular Product ID provided by another particular Vendor ID). Thus, expanders 206 and 208 each update their respective firmware based on the portion of package buffer 250 designated as “E3” (a shorthand notation for a portion corresponding to an expander of type “3”.).

In addition to updating their own firmware, each SAS expander 204, 206, and 208 also updates the firmware of any target devices directly coupled to it. For example, SAS expander 204 updates the firmware for the bridge 221 (designated as a bridge type “2”) by locating a portion identified in FIG. 2 as “B2” in package buffer 250 and transmitting that portion 252 to bridge device 221. In like manner, SAS expander 204 transmits portion 260 identified as “T2” to SAS target device 222 (a target device of type “2”). Further, in like manner, SAS expander 206 provides portion 256 (identified as “T2”) to SAS target 230, provides portion 254 (identified as “B1”) to bridge device 233, and provides portion 264 to SAS target device 228. SAS expander 208 provides portion 258 to SAS target 224 and provides portion 264 to SAS target device 226.

Thus, in the exemplary SAS storage network embodiment of FIG. 2, a package buffer 250 is generated and transmitted from SAS initiator 202 and is then automatically propagated through all expanders and target devices of SAS storage system 200 by operation of the enhanced SAS expander 204, 206, and 208.

Those of ordinary skill in the art will readily recognize that the expanders may identify portions of the package buffer associated with corresponding components/devices based on any type of identifier associated with each device. For example, a SCSI Product ID and Vendor ID may be utilized to uniquely identify each particular device/component of the storage system permitting the SAS expander to locate the corresponding portion of the package buffer that comprises firmware for each identified device. The simplified identifiers (“1”, “2”, “3”, and “E1. . . EN, B1 . . . BN, T1. . . TN, etc.) are intended merely as exemplary representations of any suitable device and vendor identification information. An exemplary Product and Vendor ID for a bridge device may include PID:LSISS25x0, VID:LSI. An exemplary expander may be identified as PID:LSI616x, VID:LSI. An exemplary SAS disk drive may be identified as PID:MBD2147RC, VID FUJITSU. Many other actual identifiers will be readily apparent to those of ordinary skill in the art. These identifiers may be embedded in headers (e.g., meta-data) in the portions of the package buffer to associate the portion with a particular type of device (identified by the combination of the PID and VID).

Still further, those of ordinary skill in the art will readily recognize that each device may determine how the firmware provided may be utilized for “updating”. As used herein, the process of “updating” may include any suitable testing to determine whether the received firmware is appropriate for installation and use on the device. For example, if the device recognizes that its present firmware is more up-to-date than the firmware represented in the portion(s) received from the package buffer, the device may simply discard the received portions and indicate in some appropriate status that the update process failed or was ignored.

Still further those of ordinary skill in the art will readily recognize that any number of devices/components may be present in SAS storage system 200 limited only by the inherent limitations of the SAS protocols and communication media. Still further, as noted above with respect to FIG. 1, SAS initiator 202 may be any SAS device capable of operating in the role of a SAS initiator. For example, SAS initiator 202 may be a host bus adapter (HBA), a storage controller or other network appliance integrated within storage system 200, or even a SAS expander taking on the role of a SAS initiator for purposes of generation and propagation of the package buffer containing firmware for all components of the storage system.

Those of ordinary skill in the art will further readily recognize that various additional and equivalent components or devices may be present in a fully functional storage system 100 or 200 of FIGS. 1 and 2. Such additional and equivalent devices or components are omitted herein for simplicity and brevity of this discussion.

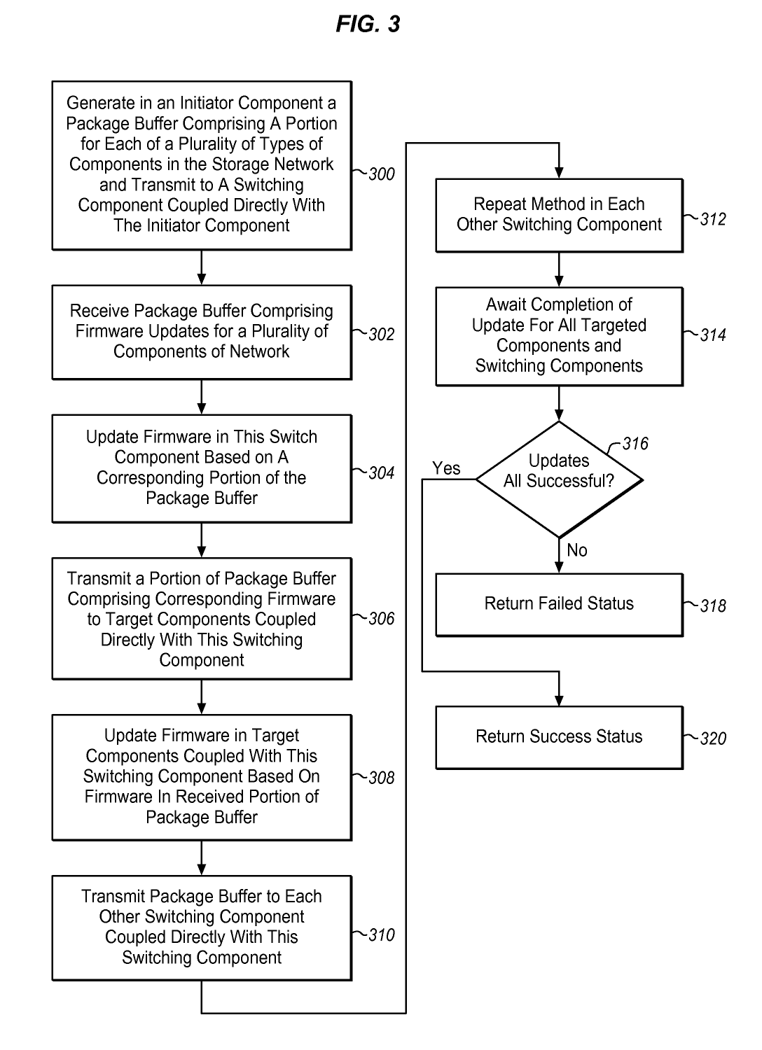

FIG. 3 is a flowchart describing and exemplary method for improved distribution and propagation of firmware updates in an enhanced storage system in accordance with features and aspects hereof The method of FIG. 3 may be operable in a storage system such as system 100 or system 200 of FIGS. 1 and 2, respectively. More specifically, the method of FIG. 3 may be operable in a variety of components of the exemplary storage systems including, for example, and initiator components, switching components, and target components of the storage system.

At step 300, an initiator component of the storage system generates a package buffer. The package buffer may comprise a portion for each type of targeted component that may be present in the storage network (i.e., a portion for multiple types of components that support field updating of its firmware). Each portion comprises firmware for a corresponding type of component in the storage network. In some exemplary embodiments, the package buffer comprises a portion for each type of component that may be present in the storage system that is capable of the improved update process hereof In other exemplary embodiments, the package buffer may comprise portions for some but not all types of components that may be present in the system. Typically, the package buffer would comprise a portion (the portion comprising firmware) for each component of the system that supports the enhanced update processing hereof The initiator component also transmits the package buffer so generated to one or more switching components directly coupled with the initiator component. At step 302, the switching component receives the package buffer transmitted from the initiator component. At step 304 the switching component updates its own firmware based on a corresponding portion of the package buffer that comprises firmware for the switching component. As noted above, each portion of the package buffer may be associated with a particular type of component that may be present in the storage network. Each component may be identified by, for example, some unique product identifier and/or vendor identifier. Such identifiers may be utilized to locate the corresponding portion of the package buffer based on appropriate header information (e.g. metadata) in the package buffer.

The switching component updates its own firmware by any suitable means to write the firmware represented by the portion of the package buffer into an appropriate memory of the switching component. For example, the located portion of the package buffer may be written into a temporary dynamic RAM location until all firmware is so stored within the switching component and verified. If the switching component then determines that the received firmware is ready and appropriate to be installed, suitable processing may be performed within the switching component to transfer the temporary copy of the firmware into persistent storage (e.g., flash memory or other electronically programmable or non-volatile memory used to persistently store firmware for the switching component). The updated firmware thereby replaces the currently operating firmware of the switching component. The particular details and timing of the update of firmware in the switching component, or any other component of the storage system, will comprise any suitable steps appropriate for the particular device according to the specifications of the manufacturer of that device.

At step 306, the switching component transmits a portion of the package buffer comprising corresponding firmware for each of a plurality of target components directly coupled to the switching component. As above, the corresponding portion of the package buffer may be identified based on appropriate device and/or vendor IDs provided by target components directly coupled with the switching component. At step 308, target components update their firmware based on the corresponding received portions of the package buffer transmitted from the switching component. In some exemplary embodiments, the portion transmitted to each target component may comprise a SCSI Write Buffer command with appropriate parameters such that by merely receiving the portion, a Write Buffer command will be executed to write the received firmware in an appropriate location of some memory of the target component. In such implementations, step 308 is not required as a separate, distinct step but rather is integrated with the processing of step 306 to transmit the portion to the target (the portion including the SCSI Write Buffer command and the firmware as data to be written by the Write Buffer command).

By operation of steps 304, 306, and 308, the switching component and a plurality of target components directly coupled with the switching component will have updated firmware based on the corresponding portions of the package buffer for each of the components. At step 310, the switching component transmits the entire package buffer to each other switching component coupled directly with this switching component. At step 312, processing of the method is repeated within each such other switching components of the storage network. In other words, each switching component directly coupled with this switching component repeats the method until all devices of the storage network have received their corresponding portion of the package buffer and have been thereby updated with corresponding firmware. In some embodiments, the method may be considered “recursive” in that each switching component performs the method and then sends the package buffer to each “lower” (e.g., downstream) switching component. Each lower/downstream switching component performs the same process until all switching components (capable of processing this method) have been provided the package buffer and have completed their processing. In such an embodiment, each switching component awaits completion of the upgrade process for each of the “lower” components directly coupled to it. In other exemplary embodiments, the package buffer may be forwarded to all switching components as an initial step. Each switching component may then perform steps to upgrade all target components directly coupled to it substantially in parallel with upgrade processing in all other switching components. These and other implementation choice for the sequence of the upgrades to be processed will be readily apparent to those of ordinary skill in the art.

Each component returns a status indication “upstream” to the component that provided it with the upgrade firmware information. The status indicates whether the upgrade succeeded or failed. Eventually the first switching component to have received the package buffer will receive status indication that all upgrades have completed. After transmitting the package buffer to all other switching components, step 314 awaits completion of the updating process for all such other switching components directly coupled with this switching component. As each target component completes its respective update, it returns a status response (e.g., a success/failure status for the SCSI Write Buffer command). Each switching component determines the success/failure status of the update of each target component updated by that switching component. Step 314 detects that all updating is completed when all such status messages are returned. Step 316 then determines whether all updates were completed successfully. If less than all updates were successful, step 318 returns a failure status to the switching component or initiator component from which it received the package buffer. If all updates were successful, step 320 returns a success status. The first switching component that received the package buffer from the initiator component eventually detects that all updates were successful or that some update(s) failed. An ultimate success/failure status is then returned to the initiator component from the first switching component that received the package buffer.

Those of ordinary skill in the art will recognize a variety of design choices for detecting and recovering from any failures in the update processing. For example, each individual component that performs an update may generate its success/failure status and return it (directly or indirectly) to the initiator component that started the update process and/or the generated the package buffer. The initiator component may thereby directly detect which component(s) failed the update process based on the return status from each device. In other embodiments, a simple aggregated success/failure message may be returned to the initiator component. The aggregated status may be accumulated in each switching component from all other components to which it transferred the package buffer or a portion of the package buffer and then transmitted upstream to the component from which the switching component received the package buffer. The aggregated status may indicate success only if all components to which the switching component sent updates succeeded in their respective update processes. Otherwise, the aggregated status indicates a failure of the update. The initiator component may then query all components of the system to determine which component(s) failed the update process.

To recover from a failed update, numerous well known design choices will be readily apparent to those of ordinary skill in the art. For example, the initiator component may retry the updates for any components/devices that failed their respective update processes. Or, for example, the initiator may ignore the failure and simply report it to an administrative user. Still further, the initiator component may “roll-back” all other successful updates of components to previous versions of firmware so assure compatibility of all components of the system.

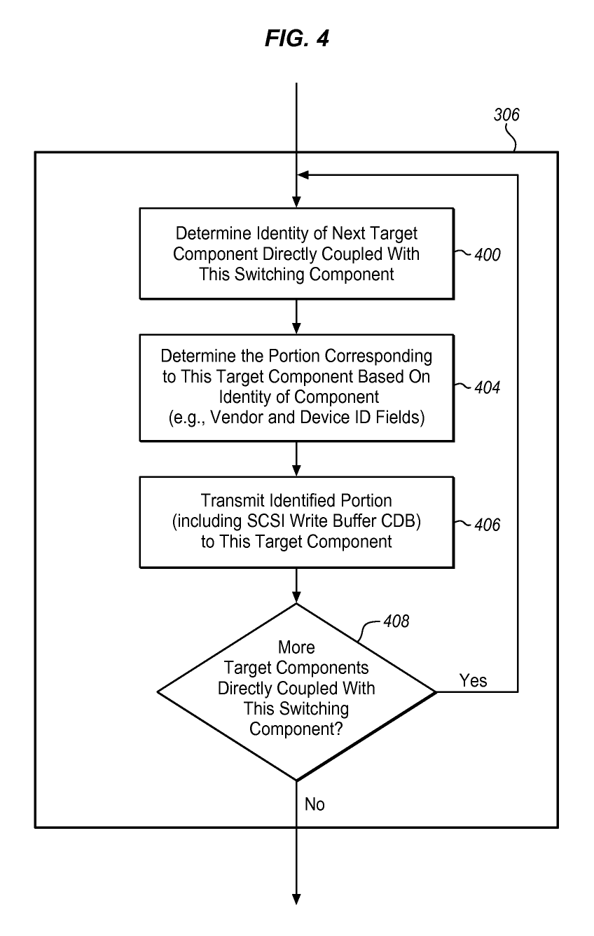

FIG. 4 is a flowchart depicting exemplary additional details of the processing of step 306 of FIG. 3. Step 306 transmits a portion of the package buffer to each target component coupled directly with the present switching component. The portion transmitted to each target component is that portion associated with the identified device (based on the device and/or vendor ID information of the target component). The portion comprises associated firmware for that identified target component/device.

At step 400, the switching component determines the identity of a next target component directly coupled with the switching component. The identity may be determined by, for example, by transmitting a SCSI Inquiry command and receiving a corresponding response. In some exemplary embodiments, such a command and response may be performed during initialization of the storage system (e.g., during SAS discovery processing) and the identity information obtained therefrom stored for later access. In other exemplary embodiments, the SCSI Inquiry command may be performed as a part of the processing of step 400. A standard response to a SCSI Inquiry may include a device identifier as well as a vendor identifier uniquely identifying a particular type of device for the target component. Based on such identification information, step 404 then determines a portion of the package buffer corresponding to this target component based on the received identification information. As discussed further herein below, each portion of the package buffer corresponds to a particular type of component or device and may include a corresponding header that it comprises identification information associated with the particular type of component or device. The header field may then be utilized to locate a corresponding portion of the package buffer based on the identification information returned in the response to the SCSI Inquiry command. At step 406, the portion so identified is transmitted to the target component. In one exemplary embodiment, each portion's header may include a SCSI Write Buffer command structure to be executed by the target component causing associated data in the identified portion to be written into particular locations in memory of the target component. Appropriate processing within step 406 may also await a status response from the target component indicating success or failure in its execution of the SCSI Write Buffer command. Such a status may be returned to appropriate other components of the system so that the initiator that commenced the update process may gather information regarding success and failure of the update processing. At step 408, the switching component determines whether additional target components are directly coupled with the switching component and need to be updated. If so, processing continues looping back to step 400 until all target components directly coupled with this switching component have received a corresponding portion of the package buffer comprising firmware to be used in updating the target component. Otherwise, processing of step 306 as detailed in FIG. 4 is complete.

Those of ordinary skill in the art will readily recognized numerous additional and equivalent steps that may be present in a fully functional method as exemplified by FIGS. 3 and 4. For example, processing to retry failed update may be provided in hopes that a retried update may succeed. Or, for example, where a particular target component indicates a device and vendor ID unknown to the switching component (e.g., not located in any portion of the package buffer), appropriate processing may generate a status response returned to other switching components and/or to the initiator indicating a component that cannot be updated. Such additional and equivalent steps are omitted herein for simplicity and brevity of this discussion.

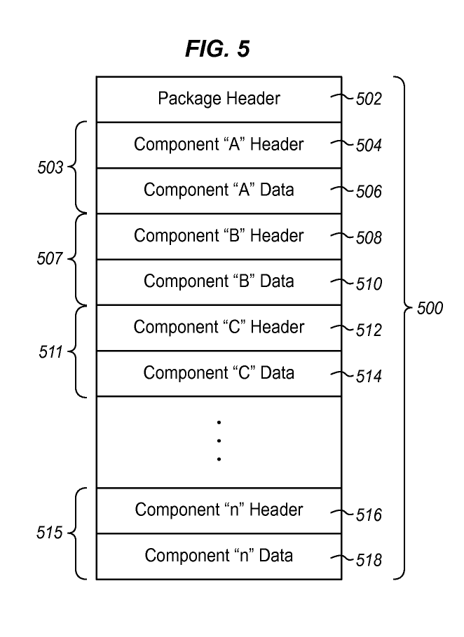

FIGS. 5 through 7 are diagrams of exemplary data structures useful in conjunction with systems and methods of FIGS. 1 through 4. FIG. 5 shows exemplary package buffer 500 comprising package header 502 and a plurality of portions 503, 507, 511, and 515. Each portion corresponds to a particular type of component in the system as indicated by the quoted component type indicator (e.g., type “A”, “B”, “C”, and “n”). Each portion comprises a header and corresponding data representing firmware to be used in updating the corresponding type of component. For example, portion 503 comprises header 504 and data 506 comprising firmware for components of type “A”. In like manner, portion 507 comprises header 508 and data 510 for components of type “B”. Portion 511 comprises header 512 and data 514 for components of type “C” and portion 515 comprises header 516 and data 518 for components of type “n”.

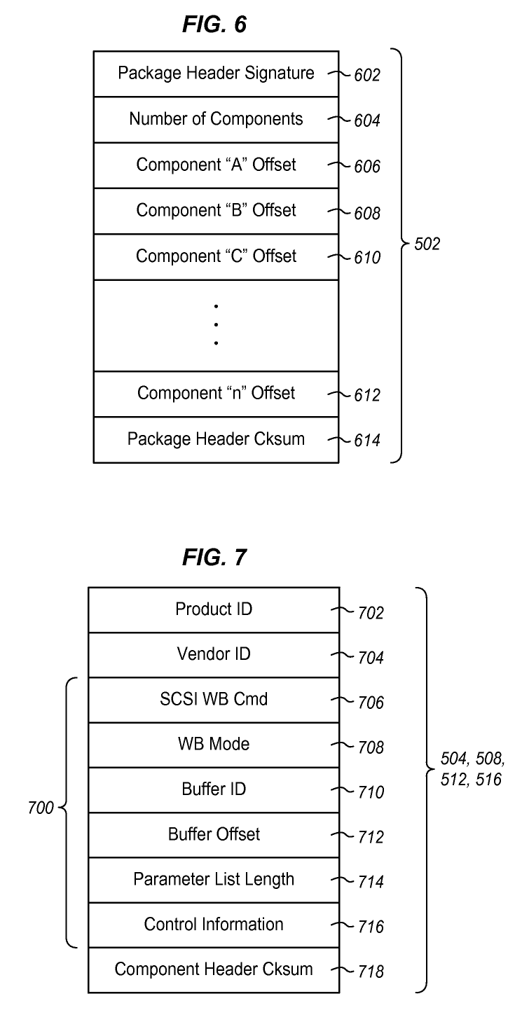

FIG. 6 shows exemplary details of package header 502 of FIG. 5. Header signature 602 may provide suitable verification that the header 502 indeed represents a proper package buffer header structure. The number of types of components having corresponding portions of firmware in the package buffer is next encoded in field 604. Each type of component then has a corresponding offset field (606, 608, 610, and 612) indicating the starting offset in the package buffer of the corresponding portion for the corresponding type of component. Lastly, a checksum field 614 may be provided to provide further verification that the package header 502 is properly encoded.

FIG. 7 shows exemplary details of component headers (504, 508, 512, and 516). Each portion of a package buffer may encode information for the corresponding type of component in the component header. Fields 702 and 704 encode the product ID and the vendor ID, respectively, that uniquely identify the type of component for which the portion has firmware data. Further, each component header (504, 508, 512, and 516) may encode a SCSI Write Buffer command structure 700 for transmission to a component of the corresponding type. The SCSI Write Buffer command is one exemplary approach for encoding information that may be transmitted to a component to cause the component to update its firmware. Fields 706 through 716 represent standard fields of a SCSI Write Buffer command used to encode parameters regarding the firmware data that will follow to be written to memory of the component. A checksum field 718 may be provided to validate that the component header comprises a proper structure (i.e., a proper SCSI Write Buffer command for this type of component). The data comprising the firmware is provided as noted above in FIG. 5 (e.g., 506, 510, 514, and 518).

Thus, in this exemplary embodiment, a switching component (or initiator component) identifies the type of each target component directly coupled to it (i.e., by the product ID and vendor ID), locates the corresponding portion in the package buffer (i.e., by comparing the IDs with the IDs encoded in each component header), and sends the SCSI Write Buffer command in the located component header and the corresponding data portion of the package buffer to the target device.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for updating firmware for a plurality of components of a storage network, the plurality of components comprising one or more switching components and one or more target components, the method comprising:
receiving in a switching component a package buffer comprising firmware for each of the plurality of components;
updating firmware in the switching component based on a portion of the package buffer comprising firmware for the switching component;
for each target component coupled directly to the switching component, performing the steps of:
transmitting from the switching component to said each target component a corresponding portion of the package buffer comprising firmware for said each target component; and
updating firmware in said each target component based on the corresponding portion of the package buffer received from the switching component; and
for each other switching component directly coupled with the switching component, performing the steps of:
transmitting the package buffer from the switching component to said each other switching component; and
repeating the method within said each other switching component.

2. The method of claim 1 wherein the storage network further comprises an initiator component and wherein the method further comprises:
generating the package buffer in the initiator component; and
transmitting the package buffer from the initiator component to the switching component.

3. The method of claim 1
wherein each portion of the package buffer further comprises a SCSI Write Buffer command used by the corresponding component to update its firmware.

4. The method of claim 1
wherein the step of transmitting a portion to each target component further comprises:
for each target component directly coupled to the switching component, performing the steps of:
determining an identity of said each target component;
determining the portion of the package buffer corresponding to said each target component based on the identity of said each target component; and
transmitting the portion to said each target component.

5. The method of claim 4
wherein the step of determining the identity further comprises:
determining the identity based on a SCSI Inquiry response received from said each target component, and
wherein the step of determining the portion further comprises:
determining the portion based on a Vendor ID field in the response to the SCSI Inquiry and based on a Product ID field in the response to the SCSI Inquiry.

6. The method of claim 1 further comprising:
for each switching component of the storage network, performing the steps of:
receiving in said each switching component an update status from each target component directly coupled to said each switching component;
returning a successful update status from said each switching component to the switching component that transmitted the package buffer in response to receiving a successful update status from said each target component directly coupled to said each switching component; and
returning a failed update status from said each switching component to the switching component that transmitted the package buffer in response to receiving a failed update status from said any target component directly coupled to said each switching component.

7. The method of claim 6
wherein the step of returning a failed update status further comprises:
returning identification information with the failed status wherein the identification information comprises information identifying a component that failed to update.

8. The method of claim 6 further comprising:
transmitting a command from the switching component to each other component of the storage network, the command requesting status information to determine which components failed to update.

9. A method for upgrading devices in a Serial Attached SCSI (SAS) storage domain, the SAS domain comprising a plurality of SAS devices, the plurality of SAS devices comprising a SAS initiator and comprising one or more SAS expanders coupled with the SAS initiator and comprising one or more SAS targets coupled with the one or more SAS expanders, the method comprising:
a) transmitting a package buffer from the SAS initiator to each SAS expander directly coupled with the SAS initiator, the package buffer comprising a one or more portions, each portion of the package buffer comprising firmware for a corresponding SAS device of the plurality of SAS devices;
b) locating, by operation of said each SAS expander, a portion of the package buffer comprising firmware corresponding with said each SAS expander;
c) updating firmware in said each SAS expander based on the firmware in the located portion of the package buffer;
d) for each SAS expander in receipt of the package buffer, performing the steps of:
transmitting the package buffer to any other SAS expanders directly coupled to said each SAS expander; and
for each SAS target directly coupled with said each SAS expander, performing the steps of:
locating, by operation of said each SAS expander, a portion of the package buffer comprising firmware corresponding with each SAS target directly coupled with said each SAS expander;;
transmitting a SCSI command comprising said portion from said each SAS expander to said each SAS target; and
updating, by operation of said each SAS target, firmware in said each target device based on firmware in said portion received from said each SAS expander; and
e) repeating steps b), c), d), and e) for each other SAS expander of the storage domain that receives the package buffer from any of said each SAS expanders.

10. The method of claim 9 wherein each SAS expander is a zoning capable SAS expander and wherein the package buffer further comprises zoning information for one or more zones of components to be updated,
wherein the method further comprises:
determining which other SAS devices coupled with said each SAS expander are to be upgraded based on the zoning information in the package buffer.

11. The method of claim 9
wherein said SCSI command comprises a SCSI Write Buffer command used by the corresponding SAS device to update its firmware.

12. The method of claim 9 further comprising:
transmitting a SCSI Inquiry from said each SAS expander to said each SAS target directly coupled to said each SAS expander;
receiving in said each SAS expander a response to the SCSI Inquiry from said each SAS target directly coupled to said each SAS expander; and
determining the portion of the package buffer corresponding to said each SAS target based on the received response to the SCSI Inquiry.

13. The method of claim 12
wherein the step of determining further comprises:
determining the portion based on a Vendor ID field in the response to the SCSI Inquiry and based on a Product ID field in the response to the SCSI Inquiry.

14. A storage system comprising:
an initiator component;
a switching component coupled with the initiator component; and
one or more target components coupled with the switching component,
wherein the switching component is adapted to receive a package buffer comprising firmware for the switching component and for the one or more target components,
wherein the switching component is further adapted to update its firmware based on a portion of the package buffer comprising firmware for the switching component,
wherein the switching component is further adapted to locate a portion of the package buffer comprising firmware for each of the one or more target components, and
wherein the switching component is further adapted to transmit the located portion for each of the one or more target components to the corresponding target component to permit update of the firmware in each of the one or more target components.

15. The system of claim 14 further comprising:
additional switching components coupled with the switching component; and
additional target components coupled to the additional switching components,
wherein the switching component is further adapted to transmit the package buffer to each of the additional switching components,
wherein said each additional switching components is adapted to update its firmware based on a portion of the package buffer comprising firmware for said each additional switching component,
wherein said each switching component is further adapted to locate a portion of the package buffer comprising firmware for each of said additional target components coupled with said each additional switching component, and
wherein the said each additional switching component is further adapted to transmit the located portion for each of said additional target components to the corresponding additional target component to permit update of the firmware in each of the additional target components.

16. The system of claim 14
wherein the system comprises a Serial Attached SCSI (SAS) storage system,
wherein the initiator component comprises a SAS initiator,
wherein the switching component comprises a SAS expander, and
wherein each target component comprises a SAS target.

17. The system of claim 16
wherein the SAS initiator comprises a SAS expander operating in the role of a SAS initiator.

18. The system of claim 14
wherein the switching component is further adapted to locate each portion in the package buffer based on an identity associated with said each target component.

19. The system of claim 18
wherein the switching component is further adapted to determine the identity of said each target component based on a response to a SCSI Inquiry command sent to said each target component.
